(19) United States
(12) Patent Application Publication
(10) Pub. No.: US 2022/0135053 A1
(43) Pub. Date: May 5, 2022

(54) VEHICLE AND METHOD OF MANAGING CONTENTS FOR THE SAME

(71) Applicants: HYUNDAI MOTOR COMPANY, Seoul (KR); KIA CORPORATION, Seoul (KR)

(72) Inventor: Hye Joo Lee, Bucheon-si (KR)

(73) Assignees: HYUNDAI MOTOR COMPANY, Seoul (KR); KIA CORPORATION, Seoul (KR)

(21) Appl. No.: 17/511,325

(22) Filed: Oct. 26, 2021

(30) Foreign Application Priority Data
Nov. 5, 2020 (KR) 10-2020-0146799

(51) Int. Cl. B60W 40/09; G07C 5/00

(52) U.S. Cl. CPC B60W 40/09; B60W 2420/42; G07C 5/008

(57) ABSTRACT

Provided are a vehicle for efficiently managing contents and a method of managing contents for the vehicle. The method of managing contents of a head unit including a memory includes: entering a menu for setting contents to be output; requesting thumbnail information to a server and receiving the thumbnail information from the server, where the thumbnail information comprises at least one thumbnail and the at least one thumbnail corresponds to at least one first content whose original is stored in the server; upon receiving a selection command corresponding to at least some of at least one thumbnail included in the received thumbnail information, and determining another content corresponding to the original to be requested to the server based on the at least some thumbnail corresponding to the selection command and at least one second content having the original previously stored in the memory.

This application claims priority to and the benefit of Korean Patent Application No. 10-2020-0146799, filed on Nov. 5, 2020, the entire contents of which are incorporated herein by reference.

### BACKGROUND

### Field

The present disclosure relates to a vehicle for efficiently managing contents and a method of managing contents for the vehicle.

### Discussion of the Related Art

The statements in this section merely provide background information related to the present disclosure and may not constitute prior art.

With the trend of enlargement of a display included in a head unit of a vehicle, types of displayable contents are being diversified and drivers are desiring various contents to be displayed through large displays.

However, a general head unit merely allows any one of previously provided images to be selected as a background image or allows themes with different color arrangements to be applied, failing to satisfy driver's needs. Thus, there has been effort to download contents such as an image desired to be displayed by a user in the head unit and to output the contents through a display of the head unit. However, we have discovered that in a head unit for a vehicle, a size of a memory allocated to store user contents is not large, and a data communication capacity available to download the contents is limited.

### SUMMARY OF THE PRESENT DISCLOSURE

The present disclosure provides a vehicle capable of efficiently managing contents and a method of managing contents for the vehicle.

Technical problems to be solved in the present disclosure are not limited to the above-mentioned technical problems, and other unmentioned technical problems may be clearly understood by those having ordinary skill in the art from the following descriptions.

To solve the foregoing technical problems, a method of managing contents of a head unit including a memory for a vehicle according to an embodiment of the present disclosure includes entering a menu for setting content to be output, requesting thumbnail information including a thumbnail regarding each of at least one first content having the original stored to a server and receiving the thumbnail information, upon receiving a selection command corresponding to at least some of at least one thumbnail included in the received thumbnail information, determining at least one third content corresponding to the original to be requested to the server, based on at least one thumbnail corresponding to the selection command and at least one second content having the original previously stored in the memory, and receiving the original of the at least one third content from the server.

A head unit for a vehicle according to an embodiment of the present disclosure includes a memory, a communication unit configured to request thumbnail information including a thumbnail regarding each of at least one first content having the original stored to a server and receive the thumbnail information, upon entering a menu for setting content to be output, and a control unit configured to determine, upon receiving a selection command corresponding to at least some of at least one thumbnail included in the received thumbnail information, at least one third content corresponding to the original to be requested to the server, based on at least one thumbnail corresponding to the selection command and at least one second content having the original previously stored in the memory, and control the original of the at least one third content to be received from the server through the communication unit.

A vehicle related to at least one embodiment of the present disclosure as described above may more efficiently manage contents.

In particular, whether to download the original content is determined through selection based on a thumbnail of the content may be determined, thereby saving the amount of wireless data usage and a storage space in a content selection process.

In addition, effects obtainable in the present disclosure are not limited to the effects described above, and other effects not described above would become apparent to those having ordinary skill in the art from the foregoing detailed description.

Further areas of applicability would become apparent from the description provided herein. It should be understood that the description and specific examples are intended for purposes of illustration only and are not intended to limit the scope of the present disclosure.

### BRIEF DESCRIPTION OF THE DRAWINGS

Arrangements and embodiments may be described in detail with reference to the following drawings in which like reference numerals refer to like elements and wherein:

FIG. 1 illustrates an example of a configuration of a system for content management, according to an embodiment of the present disclosure;

FIG. 2 illustrates an example of a configuration of a head unit, according to an embodiment of the present disclosure;

FIG. 3 is a flowchart of an example of a content management process, according to an embodiment of the present disclosure;

FIG. 4 is a flowchart of a detailed example of a content management process, according to an embodiment of the present disclosure; and

FIG. 5 is a view for describing an example of vehicle-to-vehicle content management, according to an embodiment of the present disclosure.

### DETAILED DESCRIPTION OF THE PRESENT DISCLOSURE

Hereinafter, an embodiment of the present disclosure is described in detail with reference to the attached drawings to allow those having ordinary skill in the art to easily carry out the embodiment of the present disclosure. However, the present disclosure may be implemented in various different forms, and may not be limited to the embodiment of the present disclosure described herein. To clearly describe the present disclosure, parts that are not associated with the description have been omitted from the drawings, and throughout the specification, identical reference numerals refer to identical parts.

Throughout the entire specification, if it is assumed that a certain part “includes” a certain component, it may mean that the part may further include another component rather than exclude the other component, unless specially written otherwise. Throughout the entire specification, parts referred to as identical reference numerals may mean identical components. When a component, device, element, or the like of the present disclosure is described as having a purpose or performing an operation, function, or the like, the component, device, or element should be considered herein as being “configured to” meet that purpose or to perform that operation or function.

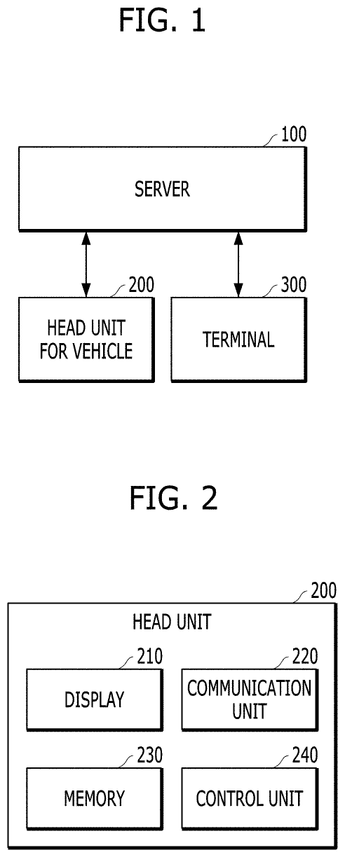

Hereinbelow, a method of managing contents and an apparatus for performing the method, according to an embodiment of the present disclosure, are described with reference to FIGS. 1 through 5. In the following description, contents are assumed to be images, but this is merely an example for convenience of a description and thus the present disclosure is not limited thereto. That is, the present disclosure is applicable to any content as long as it is possible to generate simplified information (e.g., thumbnails) for identifying the contents and output/play the contents through the head unit for the vehicle. For example, a thumbnail may be generated from a part of a video, such that the video may also correspond to content mentioned in the present disclosure. In another example, when a song tile, a player, a singer, etc., may be specified by meta data or a file name, an album image, a singer image, etc., may be generated as a thumbnail, such that audio data may also correspond to content according to the present disclosure.

FIG. 1 illustrates an example of a configuration of a system for content management, according to an embodiment of the present disclosure.

Referring to FIG. 1, the system for content management according to an embodiment of the present disclosure may include a server 100, a head unit 200 for a vehicle, and a terminal 300.

The server 100 may wirelessly perform data communication with the head unit 200. For example, the server 100 may be implemented in the form of, but not limited to, a connected car service (CCS) server or a telematics center.

The head unit 200 for a vehicle may include a display for at least displaying contents and a communication unit for communicating with the server 100. A detailed configuration of the head unit 200 is described below with reference to FIG. 2. The head unit 200 may transmit specification information and location information to the server 100. Herein, the specification information may include a display resolution, a supported image format, an image size for each mode (standby/background screen/split screen, etc.), a storage space, the maximum amount of contents allowed to be stored, etc.

The terminal 300 may be, but not necessarily limited to, a smartphone. For example, the terminal 300 may be a mobile terminal such as a smart tablet or a laptop, or a stationary terminal such as a personal computer.

The server 100, the head unit 200, and the terminal 300 may be linked to one another through one account (e.g., a CCS account). In this case, the terminal 300 may log in to the server 100 with an account on a web page provided by a CCS application or the server 100 or linked to the server 100, and upload an image captured through a camera of the terminal 300 or an image stored in the terminal 300 to the server 100. In this case, the server 100 may deliver specifications of the image to be uploaded to the terminal 300 with reference to the specification information of the head unit 200, and the terminal 300 may process (e.g., resize, crop, etc.,) the image based on the specification information and deliver the processed image to the server 100. Depending on implementation, the terminal 300 may upload the original image, and process and then store the uploaded image with reference to the specification information. In this case, the original image stored in the server 100 means the processed image.

Moreover, when the terminal 300 uploads the image to the server 100, the terminal 300 may also upload a thumbnail of the image together with the image; when the terminal 300 does not upload the thumbnail, the server 100 may generate a thumbnail for each uploaded image. In one form, the original image described below may mean a full-size image stored in the server 100 which serves as a source of a thumbnail image, and does not necessarily mean a raw image generated by an image generating device such as a camera.

FIG. 2 illustrates an example of a configuration of a head unit, according to an embodiment of the present disclosure.

Referring to FIG. 2, the head unit 200 may include a display 210, a communication unit 220, a memory 230, and a control unit 240.

In one form, the communication unit 220 may include a wireless communication modem (e.g., a Long-Term Evolution (LTE) modem, etc.) to enable wireless data communication with the server 100.

The memory 230 may store various input/output information, an operating system, applications, etc., of the head unit 200. For example, the memory 230 may store a digital frame application for displaying contents on the display 210, an image downloaded from the server 100, etc.

The control unit 240 may perform calculation, decision, determination, etc., desired for content management and output control signals to cause functions according to an embodiment, together with signals to perform overall control of the above-described components. The control unit may be implemented by at least one processor operated by a setting program, in which the setting program includes a series of commands for performing each step included in the method according to the present disclosure to be described below.

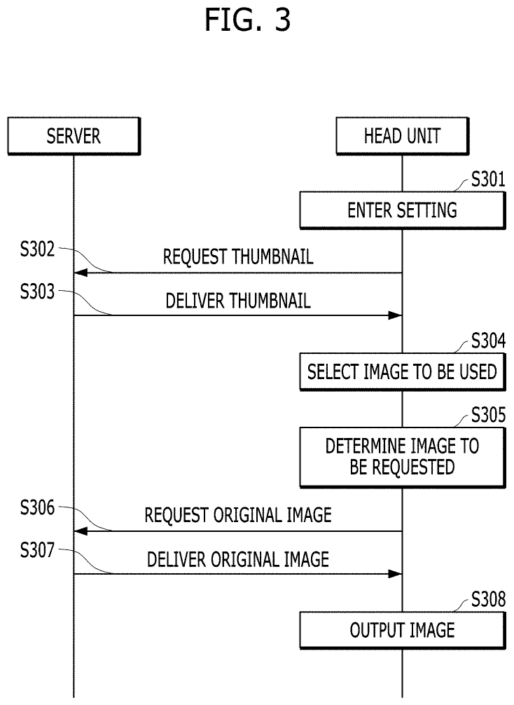

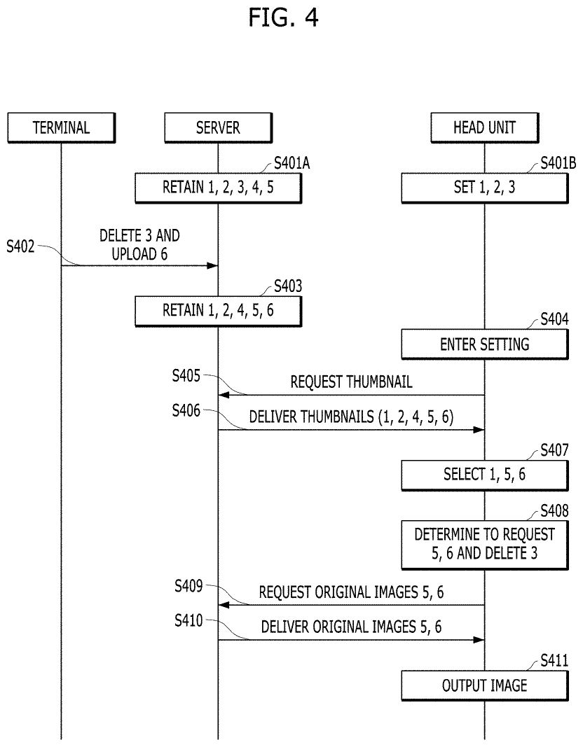

Based on the foregoing configuration of the system, a content management process is described below with reference to FIGS. 3 and 4.

FIG. 3 is a flowchart of an example of the content management process, according to an embodiment of the present disclosure.

Referring to FIG. 3, in response to input of a command from a passenger of the vehicle having the head unit 200 mounted thereon, a setting menu for setting an image to be output through an image display function such as a digital frame, etc., may be entered (S301).

Thus, the head unit 200 may request each thumbnail of at least one image that is uploaded to and stored in the server 100, to the server 100 by using an account linked to the head unit 200 (S302).

The server 100 may deliver each of the thumbnail of the at least one stored image to the head unit 200 in response to the request (S303).

The head unit 200 may output the received thumbnail through the display 210 and receive selection of at least one thumbnail corresponding to the image to be output through the image display function from the user (S304).

Thus, the head unit 200 may compare an image having the original stored in the memory 230 with the selected thumbnail image and determine a target corresponding to the original image to be requested to the server 100 (S305). In other words, the head unit 200 may determine the original of an image having the original image not stored (retained) in the memory 230 as an image to be requested to the server 100 among images corresponding to the selected thumbnail. Here, the original image that does not correspond to the thumbnail received from the server 100 may be deleted from among the original images stored in the memory 230. This is because an image retained in the head unit 200 is generally downloaded in the head unit 200 through the server 100, such that when the corresponding thumbnail is not transmitted from the server 100, it may mean that the user directly deletes the corresponding image from the server 100, which may mean a user's intention not to use the corresponding image any longer. Through such a deletion process, the original image the user does not intend to use may be automatically deleted, thereby preventing a capacity of the memory 230 from being unnecessarily used.

The head unit 200 may request the original image to the server 100 based on a determination result in the step of S306, and the server 100 may transmit the requested image to the head unit 200 (in step S307). Thus, the head unit 200 may output the image set in the step S304 through the display 210 (See, step S308). In this case, to request the original image, the head unit 200 may use a file name of a thumbnail, without being limited thereto.

FIG. 4 is a flowchart of a detailed example of the content management process, according to an embodiment of the present disclosure. In FIG. 4, a different image is indicated by one-digit number.

Referring to FIG. 4, a total of five original images 1, 2, 3, 4, and 5 are stored in the server 100 (in step S410A), and a total of three original images 1, 2, and 3 are stored in the memory 230 and are set as output targets for the image display function, in the head unit 200 (in step S401B).

In this state, the terminal 300 may access the server 100 to delete the image 3 stored in the server 100 and upload the image 6 to the server 100 (in step S402).

Thus, the server 100 may retain a total of five original images 1, 2, 4, 5, and 6 (in step S403).

In response to input of a command from a passenger of the vehicle having the head unit 200 mounted thereon, a setting menu for setting an image to be output through the image display function such as a digital frame, etc., may be entered (in step S404).

Thus, the head unit 200 may request a thumbnail regarding an image that is uploaded and stored, to the server 100 by using an account linked to the head unit 200 (in step S405).

The server 100 may deliver a thumbnail regarding each of the stored images 1, 2, 4, 5, and 6 to the head unit 200 in response to the request (in step S406).

The head unit 200 may output the received thumbnails through the display 210, and the user may select thumbnails corresponding to the images 1, 5, and 6 (in step S407).

Thus, the head unit 200 may compare the images 1, 2, and 3 having the original images retained in the memory 230 with the selected thumbnails 1, 5, and 6 and select the images 5 and 6 having the original images being absent from the memory 230 as images to be requested. The head unit 200 may also compare the images 1, 2, and 3 having the original images retained with the transmitted thumbnails 1, 2, 4, 5, and 6 and delete the image 3 not included among the transmitted thumbnails 1, 2, 4, 5 and 6 (in step S408).

The head unit 200 may request the original images 5 and 6 to the server 100 based on a determination result (in step S409), and the server 100 may transmit the requested original images 5 and 6 to the head unit 200 (in step S410). Thus, the head unit 200 may output the image set in operation S407 through the display 210 (in step S411). In this case, for determination of the original image to be requested or deleted, a file name of a thumbnail transmitted from the server 100 to the head unit 200 may be, but not limited to, that of the original image.

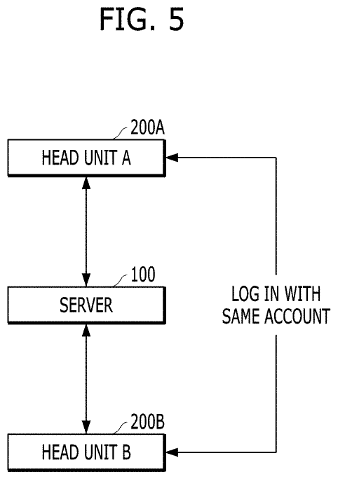

Meanwhile, the above-described method of managing contents may also be applied to different vehicles linked with the same account. This is described below with reference to FIG. 5.

FIG. 5 is a view for describing an example of vehicle-to-vehicle content management, according to an embodiment of the present disclosure.

Referring to FIG. 5, when the user transmits a list of images that are set in a head unit 200A of a vehicle A to the server 100 of the head unit 200A, as the user logs in to a head unit 200B of a vehicle B with an account of the user, the server 100 may apply the same settings to the head unit 200B of the vehicle B (i.e., synchronize the head unit 200B to the head unit 200A), based on the list of the set images. In this case, when the original image deleted from the server 100 is included among the images included in the list of the set images, the server 100 may reflect the settings to the head unit 200B of the vehicle B except for the deleted original image.

With the method of managing contents according to embodiments described so far, optimized data usage may be possible in an environment where the amount of data usage is limited. That is, instead of receiving the entire original image from the server 100 and then selecting an image to be displayed, only a thumbnail may be received to determine the original image that needs to be actually downloaded, thereby saving the memory 230 of the head unit 200 as well as the amount of wireless data usage. Moreover, the image having the original image deleted from the server 100 is automatically deleted from the memory 230, thereby preventing the original image the user does not intend to use from being accumulated in the memory 230.

The present disclosure described above may be implemented as a computer-readable code on a medium in which a program is recorded. A computer-readable medium may include any type of recording devices that store data readable by a computer system. Examples of computer-readable medium may include a hard disk drive (HDD), a solid-state disk (SSD), a silicon disk drive (SDD), read-only memory (ROM), random access memory (RAM), compact disc-ROM (CD-ROM), a magnetic tape, a floppy disk, an optical data storage device, etc.

A vehicle related to at least one embodiment of the present disclosure as described above may more efficiently manage contents.

In particular, whether to download the original content is determined through selection based on a thumbnail of the content may be determined, thereby saving the amount of wireless data usage and a storage space in a content selection process.

In addition, effects obtainable in the present disclosure are not limited to the effects described above, and other effects not described above would become apparent to those having ordinary skill in the art from the foregoing detailed description.

Accordingly, the detailed description should not be construed as restrictive in all respects, but as exemplary. The scope of the present disclosure should be determined by reasonable interpretation of the appended claims, and all modifications within the equivalent scope of the present disclosure may be included in the scope of the present disclosure.

What is claimed is:

1. A method of managing contents of a head unit comprising a memory for a vehicle, the method comprising:
entering a menu for setting a content to be output;
requesting thumbnail information to a server and receiving the thumbnail information from the server, wherein the thumbnail information comprises at least one thumbnail and the at least one thumbnail corresponds to at least one first content whose original is stored in the server;
upon receiving a selection command corresponding to at least some of the at least one thumbnail included in the received thumbnail information, and based on the at least some thumbnail corresponding to the selection command and at least one second content whose original is previously stored in the memory, determining at least one third content whose original to be requested to the server; and
receiving the original of the at least one third content from the server.

2. The method of claim 1, wherein the determining of the at least one third content comprises: determining, as the at least one third content, at least one content that does not correspond to the at least one second content among the at least some thumbnail corresponding to the selection command.

3. The method of claim 1, further comprising: deleting, from the memory, at least one original of content that does not correspond to the at least one thumbnail included in the received thumbnail information among the at least one second content.

4. The method of claim 1, further comprising: upon receiving the original of the at least one third content from the server, outputting, on a display, a content corresponding to the at least some thumbnail corresponding to the selection command.

5. The method of claim 4, wherein the outputting is performed through a digital frame application.

6. The method of claim 1, further comprising: transmitting, to the server, a result of setting the content to be output corresponding to the at least some thumbnail corresponding to the selection command.

7. The method of claim 6, further comprising: synchronizing, by the server, a device logging in with a user account that is the same as a user account of the head unit based on the result of setting the content to be output to settings of the content to be output.

8. A non-transitory computer-readable recording medium having a program recorded thereon, the program to direct a processor to perform acts of:
entering a menu for setting a content to be output;
requesting thumbnail information to a server and receiving the thumbnail information from the server, wherein the thumbnail information comprises at least one thumbnail and the at least one thumbnail corresponds to at least one first content whose original is stored in the server;
upon receiving a selection command corresponding to at least some of the at least one thumbnail included in the received thumbnail information, and based on the at least some thumbnail corresponding to the selection command and at least one second content whose original is previously stored in a memory, determining at least one third content whose original to be requested to the server; and
receiving the original of the at least one third content from the server.

9. A head unit for a vehicle, the head unit comprising:
a memory;
a communication unit configured to:
request thumbnail information comprising at least one thumbnail to a server, each of the at least one thumbnail corresponding to at least one first content whose original is stored in the server, and
receive the thumbnail information from the server upon entering a menu for setting a content to be output; and
a control unit configured to:
upon receiving a selection command corresponding to at least some of the at least one thumbnail included in the received thumbnail information, and based on the at least some thumbnail corresponding to the selection command and at least one second content whose original is previously stored in the memory, determine at least one third content whose original to be requested to the server, and control the original of the at least one third content to be received from the server through the communication unit.

10. The head unit of claim 9, wherein the control unit is further configured to determine, as the at least one third content, at least one content that does not correspond to the at least one second content among the at least some thumbnail corresponding to the selection command.

11. The head unit of claim 9, wherein the control unit is further configured to delete, from the memory, at least one original of content that does not correspond to the at least one thumbnail included in the received thumbnail information among the at least one second content.

12. The head unit of claim 9, further comprising: a display configured to output content corresponding to the at least some thumbnail corresponding to the selection command upon receiving the original of the at least one third content from the server.

13. The head unit of claim 12, wherein the control unit is further configured to control the content corresponding to the at least some thumbnail corresponding to the selection command to be output through a digital frame application.

14. The head unit of claim 9, wherein the control unit is further configured to control the communication unit to transmit a result of setting the content to be output corresponding to at least one thumbnail corresponding to the selection command to the server.
